(19) United States
(12) Patent Application Publication
(10) Pub. No.: US 2016/0365735 A1
(43) Pub. Date: Dec. 15, 2016

(54) Systems and Methods for Power Plant Data Reconciliation

(71) Applicant: General Electric Company, Schenectady, NY (US)

(72) Inventors: Christopher Michael Raczynski, Atlanta, GA (US); Larry William Swanson, Irvine, CA (US); Lisa Anne Wichmann, Atlanta, GA (US); Matthew Colin Michael, Clifton Park, NY (US); Uttam Narasimhan, Plantation, FL (US)

(21) Appl. No.: 14/734,691

(22) Filed: Jun. 9, 2015

(51) Int. Cl. H02J 3/46; G05B 17/02

(52) U.S. Cl. CPC H02J 3/46; G05B 17/02

(57) ABSTRACT

Systems and methods for power plant data reconciliation are provided. According to one embodiment of the disclosure, a system may include a controller and a processor in communication with the controller. The processor may be configured to run a power plant under a plurality of operational conditions. While the power plant is running, the processor may be configured to automatically collect operational data associated with the power plant. The collected data may be stored in a predefined location. Furthermore, the processor may be configured to select stable data from the operational data to coincide with output data associated with a power plant model. One or more parameters of the power plant model may be modified, and at least one difference may be minimized between the output data associated with the power plant model and a measured value in the power plant operational data. At least one control action for a power plant component using the power plant model may be determined

### TECHNICAL FIELD

This disclosure relates generally to combined cycle power plants, and more particularly, to systems and methods for power plant data reconciliation.

### BACKGROUND

Power plants can generate power with relatively high thermal efficiency, reliability, and cost-effectiveness. A combined cycle power plant may include a combustion turbine, a steam generator, and a steam turbine. The steam turbine of a combined cycle power plant is powered by the steam generated by the hot exhaust of the combustion turbine in the steam generator.

Degradation of power plant components can be analyzed by personnel utilizing a tuned model of the power plant. However, power plant data used for input to conventional tuned models may be incomplete, inaccurate, and relatively difficult to interpret. In certain instances, conventional tuned models are not maintained, and as the physical plant degrades over time, tuning values used as inputs for the models will be inaccurate. Without relatively accurate model inputs and proper model maintenance, tuned models will be unreliable, and power plant and component performance and degradation will not be accurately predicted.

### BRIEF SUMMARY OF THE DISCLOSURE

Embodiments of the disclosure relate to systems and methods for power plant data reconciliation. In certain embodiments, systems and methods can be provided for utilizing a unique data reconciliation procedure to automatically calibrate and tune a computer based virtual model of the power plant. According to one embodiment of the disclosure, a method is provided. The method may include running a power plant under a plurality of operational conditions. While the power plant is running, operational data associated with the power plant may be automatically collected. The collected data may be stored in a predefined location. Thermally stable data from the operational data may be selected to coincide with output data associated with a power plant model. One or more parameters of the power plant model may be modified, and at least one difference may be minimized between the output data associated with the power plant model and a measured value in the power plant operational data. At least one control action for a power plant component using the power plant model may be determined

In another embodiment of the disclosure, a system is provided. The system may include a controller and a processor in communication with the controller. The processor may be configured to run a power plant under a plurality of operational conditions. While the power plant is running, the processor may be configured to automatically collect operational data associated with the power plant. The collected data may be stored in a predefined location. Furthermore, the processor may be configured to select thermally stable data from the operational data to coincide with output data associated with a power plant model. One or more parameters of the power plant model may be modified, and at least one difference may be minimized between the output data associated with the power plant model and a measured value in the power plant operational data. At least one control action for a power plant component using the power plant model may be determined

In yet another embodiment of the disclosure, another system is provided. The system may include power plant equipment, a controller in communication with the power plant equipment, and a processor in communication with the controller. The controller may include power plant control system to control operation of components of the power plant. The processor may be configured to run the power plant under a plurality of operational conditions. While the power plant is running, the processor may be configured to automatically collect operational data associated with the power plant. The collected data may be stored in a predefined location. Furthermore, the processor may be configured to select thermally stable data from the operational data to coincide with output data associated with a power plant model. One or more parameters of the power plant model may be modified, and at least one difference may be minimized between the output data associated with the power plant model and a measured value in the power plant operational data. At least one control action for a power plant component using the power plant model may be determined

Other embodiments, systems, methods, apparatus, aspects, and features of the disclosure will become apparent from the following detailed description, the accompanying drawings, and the appended claims.

### BRIEF DESCRIPTION OF THE DRAWINGS

FIG. 1 is a block diagram illustrating an example environment and system for power plant data reconciliation in a power plant according to an embodiment of the disclosure.

FIG. 2 depicts a process flow diagram of an example method for data reconciliation of a power plant, in accordance with an embodiment of the disclosure.

FIG. 3 illustrates an example process flow diagram for data reconciliation of a power plant, in accordance to an embodiment of the disclosure.

FIG. 4 is a block diagram illustrating an example controller for controlling a power plant, in accordance with an embodiment of the disclosure.

### DETAILED DESCRIPTION

The following detailed description includes references to the accompanying drawings, which form part of the detailed description. The drawings depict illustrations, in accordance with example embodiments. These example embodiments, which are also referred to herein as “examples,” are described in enough detail to enable those skilled in the art to practice the present subject matter. The example embodiments may be combined, other embodiments may be utilized, or structural, logical, and electrical changes may be made, without departing from the scope of the claimed subject matter. The following detailed description is, therefore, not to be taken in a limiting sense, and the scope is defined by the appended claims and their equivalents.

Certain embodiments described herein relate to a system and methods for power plant data reconciliation.

In one embodiment, automated data reconciliation of the power plant can be implemented to replace conventional manual data collection and operating procedures. A power plant model or “digital” or “virtual” twin of the power plant can be generated to behave similarly to the power plant. To generate the power plant model, the power plant can be run under various operational conditions, including various combustor temperatures, airflows, fuel flows, and so forth. The power plant can be kept within predetermined operational boundaries while performing test runs. The operational boundaries may include emissions, dynamics, lean blow-out, and the like. Operational data associated with the power plant running various operational conditions may be automatically collected and stored. A power plant data reconciliation module can compare and reconcile data between a power plant model and the power plant through one or more data quality checks to ensure that sufficient measurements from one or more sensors associated with the power plant are present for tuning the power plant model. A thermal stability and baseload check may also be performed by the power plant data reconciliation module to select certain power plant operational data that coincides with one or more power plant operating conditions which may align output data from the power plant model with certain physical behavior of the power plant. In certain embodiments, sufficient operation data may be determined when there exists at least thirty stable data points within the data set that is being reconciled. Stable data refers to data from the power plant that has been determined to the thermally stable. Thermally stable refers to over the course of some duration the values have not deviated from a predetermined threshold. In one example embodiment, the duration for collecting the stable data may be for about 5 to 15 minutes, and the deviation of the data values may be in the range of about 1 to 3%. In certain embodiments, the physics based model may only be accurate when compared with a thermally stable plant such that scoring each data point as to its stability is necessary. The power plant data reconciliation module may further modify one or more tuning parameters of the power plant model to minimize any differences between the measured power plant operating data and the operating data calculated by the power plant model.

The technical effects of certain embodiments of the disclosure may include predicting, identifying, and reducing isolated and/or recurring instances of component degradation, failures, and/or malfunctions in a power plant. Other technical effects of certain embodiments of the disclosure may include early detection of malfunctions, abnormal conditions, and power plant process deviations, which can minimize instances of failures, tripping, and shutdown of the power plant and/or associated components.

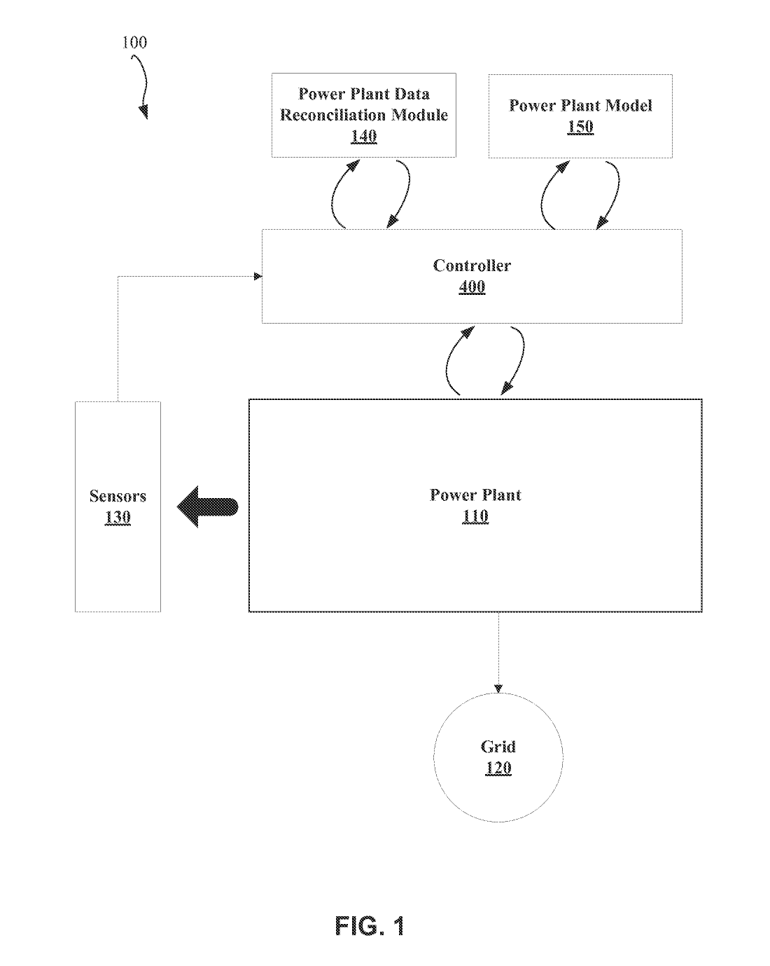

Referring now to FIG. 1, a system environment 100 is shown for implementing power plant data reconciliation, in accordance with one or more example embodiments. The system environment 100 may include a power plant 110 in communication with a power or electrical grid 120, one or more sensors 130, a power plant data reconciliation module 140 with a power plant model 150, and a controller 400.

In an example embodiment, a power plant, such as 110, may be a combined cycle power plant, which may include a gas turbine and a steam turbine powered by the steam generated by the hot exhaust of the gas turbine. Generally, a power plant, such as 110, may include one or more power plant components, such as, for example, a gas turbine, a steam turbine and/or one or more associated components. Each component may be monitored by or otherwise include one or more sensors, such as 130, operable to receive or otherwise obtain respective process measurements from the respective component and/or power plant. For example, measurements can include, but are not limited to, gas turbine power, gas turbine compressor pressure and temperature, gas turbine exhaust temperature, gas turbine fuel flow rate, gas turbine inlet pressure drop, feedwater flow rates, steam turbine flow rates, steam turbine temperatures and pressures, admission temperatures, steam turbine power, condenser steam saturation temperature, and condenser cooling water temperatures.

In some embodiments, the power plant 110 may further include a monitoring system operable to receive one or more values associated with one or more sensors, such as 130. The values can be transmitted by the monitoring system to the controller 400.

In any instance, operation of the power plant 110 may be monitored by one or more sensors 130 detecting or otherwise receiving various conditions and operational data of the power plant 110, and sensing or otherwise receiving parameters associated with the system environment 100. For example, one or more sensors may detect or receive ambient temperature measurements surrounding the power plant 110. In another example, one or more sensors may detect or receive temperature measurements associated with components inside a typical power plant, e.g. gas turbine or combined-cycle. In yet another example, one or more sensors may detect or receive particular temperature measurements, such as compressor discharge temperature, turbine exhaust gas temperature, and other temperature measurements of the gas stream through the gas turbine. In another example, one or more sensors may detect or receive pressure measurements, such as ambient pressure, static and dynamic pressure levels at the compressor inlet and outlet, and turbine exhaust, as well as at other locations in the gas stream. Further, in another example, one or more sensors may detect or receive humidity measurements, such as humidity sensors (e.g., wet and dry bulb thermometers) detecting or receiving ambient humidity measurements in the inlet duct of the compressor. In another example, one or more sensors may detect or receive emission level measurements in a turbine exhaust. The one or more sensors 130 may also include flow sensors, speed sensors, flame detector sensors, valve position sensors, guide vane angle sensors, or the like that sense various parameters pertinent to the operation of the power plant. As used herein, the term “operational data” and similar terms refer to any data defining one or more parameters affecting power plant operation, such as temperatures, pressures, and flows at defined locations in a power plant 110. Further, operational data may include information that represents dependencies between reference conditions and the power plant response. Moreover, operational data may include information as associated with component degradation in the power plant, such as gas turbine exhaust or steam turbine flow rates, which may be used in determining component degradation.

Upon receipt of operational data from the one or more sensors 130, the controller 400 may interact with the power plant data reconciliation module 140 to provide operational commands to the power plant 110 to perform under specific operational conditions.

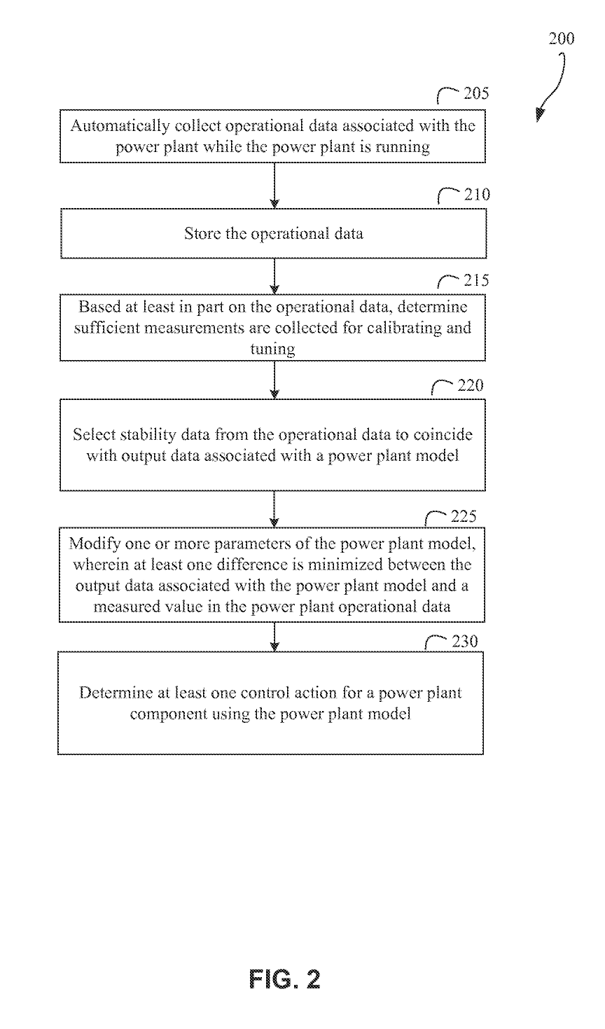

FIG. 2 depicts a process flow diagram illustrating an example method 200 for power plant data reconciliation, in accordance with an embodiment of the disclosure. The method 200 may be performed by processing logic that may comprise hardware (e.g., dedicated logic, programmable logic, and microcode), software (such as software run on a general-purpose computer system or a dedicated machine), or a combination of both. In one example embodiment, processing logic can reside at a controller, such as 400 shown in FIG. 1, which may reside in a plant control computer, user computer device, or in a server. The controller 400 can communicate with a power plant data reconciliation module, such as 140 shown in FIG. 1, and access an associated power plant model, such as 150 in FIG. 1. It will be appreciated that instructions to be executed by the controller 400 may be retrieved and executed by one or more associated computer processors. The controller 400 may also include memory cards, servers, and/or computer discs. Although the controller 400 may be configured to perform one or more operations described herein, other numbers of control units may be utilized by various embodiments.

As shown in FIG. 2, the method 200 may commence at operation 205 with the controller 400 automatically collecting operational data associated with the power plant while the power plant is operating. The operational data is collected from the one or more sensors 130 shown in FIG. 1, which can detect or otherwise receive the operational data from the power plant 110, such as a combined cycle power plant, and/or the system environment 100. The operational data may be detected or received in real-time or near real-time, and processed by the controller 400.

At operation 210, the controller 400 stores the collected operational data in memory or in a database associated with the controller 400.

At operation 215, the controller 400, based at least in part on the collected operational data, determines if sufficient measurements have been collected for calibrating and tuning a power plant model, such as 150 in FIG. 1. Data quality checks may be performed by the controller 400 to ensure that sufficient measurements are present in the model 150 for the tuning to proceed. In certain embodiments, sufficient measurements may be determined when there exists at least thirty stable data points within the data set that is being reconciled. Stable data refers to data from the power plant that has been determined to the thermally stable. Thermally stable means that over the course of some duration the values have not deviated from a predetermined threshold.

At operation 220, the controller 400 selects stability data from the collected operational data to coincide with output data associated with the power plant model. In one example embodiment, both stability data and baseload data may be selected from the collected operational data by the controller 400. A stability and baseload check may also be performed by the controller 400 to select certain operational data that coincides with one or more power plant operating conditions that which may align output data from the power plant model 150 with certain physical behavior of the power plant.

At operation 225, the controller 400 modifies one or more parameters of the power plant model 150. In some embodiments, the controller 400 can minimize at least one difference between the output data from the power plant model 150 and a measured value in the power plant operational data. An optimizer process used by the controller 400 may modify one or more tuning parameters within the power plant model 150 to minimize the difference between a measured value in the power plant operational data and data outputs calculated or generated by the power plant model 150. In some embodiments, the controller 400 may use a global optimizer process combined with a gradient-based optimizer process to identify and remove any local minima

At operation 230, the controller 400 determines at least one control action for a power plant component using the power plant model. In one embodiment, the control action can include a signal generated by the controller 400, wherein the signal is operable to affect operation of the power plant and/or a component of the power plant 110. In another embodiment, the control action may include a communication generated by the controller 400, and transmitted by the controller 400 to a user device, such as a personal computer or mobile device associated with or otherwise operated by plant personnel. The communication may be received by one or more plant personnel monitoring one or more power plant components that may be failing due to degradation, based on one or more calculations previously determined by the power plant model 150.

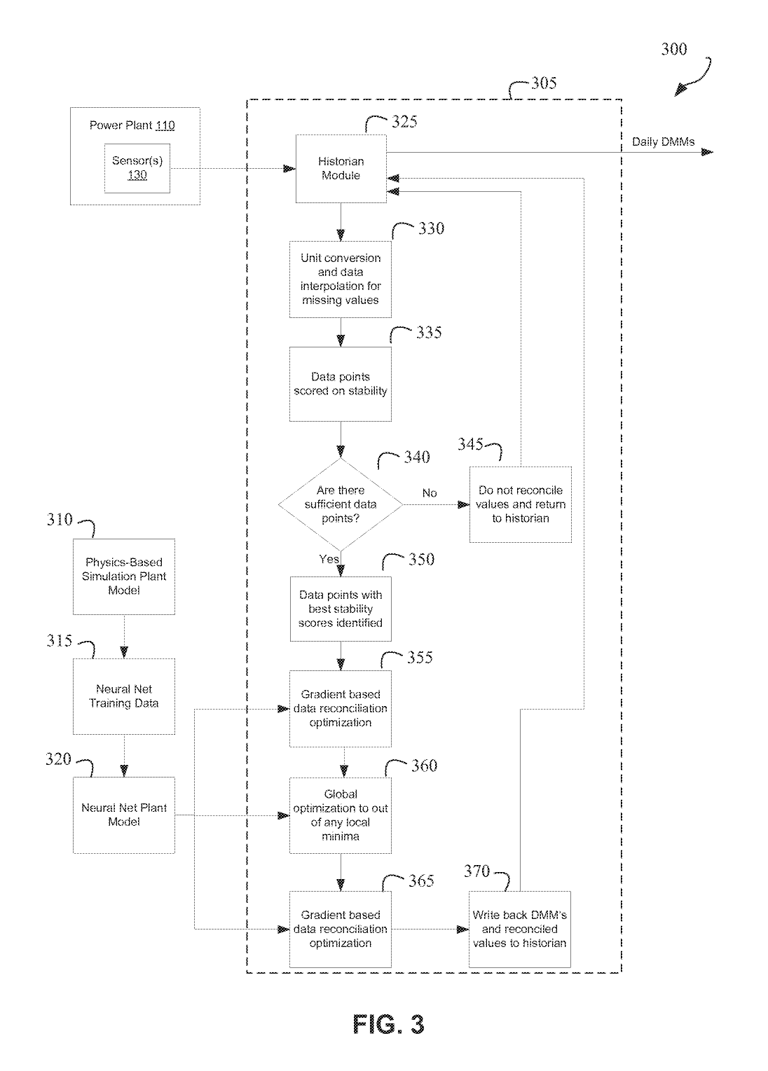

FIG. 3 depicts a process flow diagram illustrating a detailed example method 300 for power plant data reconciliation in a combined cycle power plant, in accordance with an embodiment of the disclosure.

The method 300 may start with operational data from one or more sensors 130 associated with the power plant 110 being sent by the controller 400 to a daily data reconciliation process 305, and controlled and recorded by a historian module 325. The operational data from the one or more sensors 130 may be collected at a certain interval of time as predetermined by plant personnel, such as an engineer or user of the system, e.g. every minute, hour, etc. In the example embodiment, operational data may be collected daily in five minute intervals.

During the daily data reconciliation process 305, various operational data and conditions may be examined by the controller 400. The operational data may include gas turbine power, gas turbine compressor pressure and temperature, gas turbine exhaust temperature, gas turbine fuel flow rate, gas turbine inlet pressure drop, feedwater flow rates, steam turbine flow rates, steam turbine temperatures and pressures, admission temperatures, steam turbine power, condenser steam saturation temperature, condenser cooling water temperatures, and so forth.

The historian module 325 may collect the operational data and unit conversion and data interpolation for missing values may be performed during operation 330. Operation 330 may be implemented by the controller 400 to ensure accurate and complete data sets are created. Then, at operation 335, the data points may be scored by the controller 400 on stability. In an example embodiment, the stability scores may be based on, e.g., the difference between the value of the data, and the rolling average of the past three minutes of data. In another example embodiment, the data points may also be checked for being at a baseload.

In operation 340, the controller 400 may determine whether the data set is sufficient enough to continue with the daily data reconciliation process 305. If is the controller 400 determines that the data set may not be sufficient, the method may continue with the operation 345, wherein the data values are not reconciled, and the method returns to the historian module 325. If it is determined that the data set may be sufficient, the method 300 may continue with the operation 350, and the data points with the best stability scores may be identified by the controller 400. In another example embodiment, thirty baseload points with the best stability scores may be identified by the controller 400.

In operation 355, the daily data reconciliation process 305 may continue with a gradient based data reconciliation optimization performed by the controller 400. Operation 355 may be implemented by the controller 400 to utilize both the data points with best stability scores from operation 350, and the neural net plant model 320 data. In an example embodiment, a global optimizer module may be used by the controller 400 in operation 360 to identify any local minima by using the data from operation 355 and the data produced from the net plant model 320. At operation 365, a second gradient based optimizer module may be implemented by the controller 400, using the data from operation 360, and the data produced from the net plant model 320. In another example embodiment, the gradient based data reconciliation optimization 365 operation may be used by the controller 400 for one or more additional analysis.

In another embodiment, the method 300 may start with a physics-based simulation plant model, such as 310, also known as a tuned thermal model. The physics-based simulation plant model 310 may be a calibrated system model of components that rigorously satisfies heat/mass/pressure balances of a virtual model of a power plant. Power plant personnel, such as engineers, may be able to enter the capability of the plant at certain loads to represent the capability of the plant at an optimum current performance based on original equipment manufacturers (“OEM”) specifications as a test performance. The test performance may initialize a performance parameter index, or data match multiplier (“DMM”), to a value of “1” to indicate a new or clean system. A DMM=1 may be used as a baseline for the data reconciliation process for the system to compare each component to distinguish degradation during the life of the equipment. A DMM<1 would signify component degradation, and a DMM>1 would signify there may be an improvement in the performance of the component compared to the test performance. The DMMs may represent the physical degradation at the plant so they can be used to characterize where power and heat rate are being lost. The DMMs may be reflective of physical and/or hardware changes, not when a flow or temperature with in the power plant is changed. Degradation in specific components impact efficiencies of each respective component. In an example embodiment, engineers may perform a test performance utilizing the OEM specifications for steady baseload data.

At the next operation 315, the physics-based simulation plant model 310 data may be sent by the controller 400 to create neural net training data, operation 315, and then to train a neural net plant model 320. A power plant simulator program, e.g. General Electric Company's GateCycle® simulator program, or similar simulator program, may be used to generate a set of training data for a neural-net surrogate model of the plant, which replaces the heat and mass balance constraint equations. This operation may utilize a design of experiments (“DOE”) as a formal selection methodology that minimizes the number of tests needed to characterize a model. The neural-net surrogate model may be used by the controller 400 to reconcile plant data and determine DMMs and performance factors, indicative of plant component degradation by sending the neural-net surrogate model data to at least two or more gradient based data reconciliation optimization operations 355, 365, and at least one global optimization module to identify any local minima at operation 360, as described herein for the daily data reconciliation process 305. After the final gradient-based optimizer is utilized by the controller 400, the DMM's may be written back by the controller 400 and reconciled values may be sent to the historian module 325 in operation 370. After reconciling and receiving the updated DMM's, the historian module 325 may report out the daily DMM's to any number of systems or operations. In another example embodiment, the historian module 325 may report out the daily DMM's to a forecasting performance model as a variable load component for an additional neural net operation.

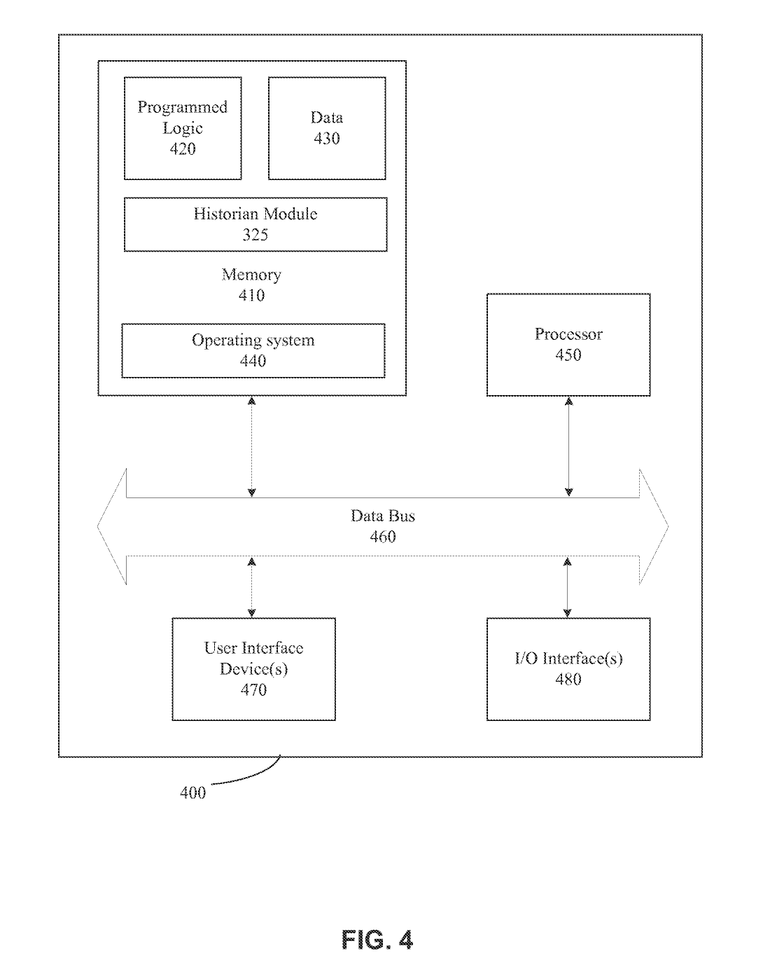

FIG. 4 depicts a block diagram illustrating an example controller 400 for power plant data reconciliation, in accordance with an embodiment of the disclosure. More specifically, the elements of the controller 400 may be used to run a power plant under any number of operational conditions, automatically collect operational data associated with the power plant from sensors, store the operational data, determine sufficient measurements are collected for calibrating and tuning, select stability data from the operational data to coincide with output data associated with a power plant model, The controller 400 may include a memory 410 that stores programmed logic 420 (e.g., software) and may store data 430, such as operational data associated with the gas turbine, the set of constants, and the like. The memory 410 also may include an operating system 440.

A processor 450 may utilize the operating system 440 to execute the programmed logic 420, and in doing so, may also utilize the data 430. A data bus 460 may provide communication between the memory 410 and the processor 450. Users may interface with the controller 400 via at least one user interface device 470, such as a keyboard, mouse, control panel, or any other device capable of communicating data to and from the controller 400. The controller 400 may be in communication with the power plant online while operating, as well as in communication with the power plant offline while not operating, via an input/output (I/O) interface 480. Additionally, it should be appreciated that other external devices or multiple other gas turbines or combustors may be in communication with the controller 400 via the I/O interface 480. In the illustrated embodiment, the controller 400 may be located remotely with respect to the power plant; however, it may be co-located or even integrated with the gas turbine. Further, the controller 400 and the programmed logic 420 implemented thereby may include software, hardware, firmware, or any combination thereof It should also be appreciated that multiple controllers 400 may be used, whereby different features described herein may be executed on one or more different controllers 400.

Accordingly, certain embodiments described herein may alleviate complexity and susceptibility to errors of updating and keeping accurate a virtual model of the physical plant conditions over time with little to no engineering man-hours. The disclosed methods and systems for data reconciliation facilitated by software and analytics applications may standardize and reduce errors in the data reconciliation process. Additionally, the disclosed methods provide tuning parameters that represent the physical degradation at the plant so they can be used to characterize where power and heat rate are being lost.

References are made to block diagrams of systems, methods, apparatuses, and computer program products according to example embodiments. It will be understood that at least some of the blocks of the block diagrams, and combinations of blocks in the block diagrams, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide steps for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based or programmable consumer electronics, mini-computers, mainframe computers, and the like.

Application programs that are components of the systems and methods described herein may include routines, programs, components, data structures, and so forth that implement certain abstract data types and perform certain tasks or actions. In a distributed computing environment, the application program (in whole or in part) may be located in local memory or in other storage. In addition, or alternatively, the application program (in whole or in part) may be located in remote memory or in storage to allow for circumstances where tasks are performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated that the disclosure may be embodied in many forms and should not be limited to the example embodiments described above. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method for implementing data reconciliation using a power plant model, comprising:
receiving, by at least one processor, power plant operational data;
selecting, by at least one processor, thermally stable data from the operational data to coincide with output data associated with a power plant model;
modifying, by at least one processor, one or more parameters of the power plant model, wherein at least one difference is minimized between the output data associated with the power plant model and a measured value in the power plant operational data; and
determining, by at least one processor, at least one control action for a power plant component using the power plant model.

2. The method of claim 1, wherein the operational data comprises at least one of the following: gas turbine power, gas turbine compressor pressure and temperature, gas turbine exhaust temperature, gas turbine fuel flow rate, gas turbine inlet pressure drop, feedwater flow rates, steam turbine flow rates, steam turbine temperatures and pressures, admission temperatures, steam turbine power, condenser steam saturation temperature, and condenser cooling water temperatures.

3. The method of claim 1, wherein the selecting stable data comprises checking the operational data and scoring the data points based at least in part on stability.

4. The method of claim 1, wherein the modifying is based at least in part on performing: an initial analysis of gradient-based data reconciliation optimization, global-based data reconciliation optimization to remove any local minima, and one or more additional analysis of gradient-based data reconciliation optimization.

5. The method of claim 1, wherein the power plant model is based at least in part on a neural-net surrogate model, wherein the neural-net surrogate model indicates plant component degradation by reconciling the operational data, determining data match multipliers (DMMs), and determining performance factors.

6. The method of claim 5, wherein the neural net surrogate model is created based on a physics based model.

7. The method of claim 5, wherein the control action is determined from the DMMs and the performance factors.

8. A system for implementing data reconciliation using a power plant model, comprising:
a controller; and
a processor communicatively coupled to the controller and configured to:
receive power plant operational data;
select stable data from the operational data to coincide with output data associated with a power plant model;
modify one or more parameters of the power plant model, wherein at least one difference is minimized between the output data associated with the power plant model and a measured value in the power plant operational data; and
determine at least one control action for a power plant component using the power plant model.

9. The system of claim 8, wherein the operational data comprises at least one of the following: gas turbine power, gas turbine compressor pressure and temperature, gas turbine exhaust temperature, gas turbine fuel flow rate, gas turbine inlet pressure drop, feedwater flow rates, steam turbine flow rates, steam turbine temperatures and pressures, admission temperatures, steam turbine power, condenser steam saturation temperature, and condenser cooling water temperatures.

10. The system of claim 8, wherein the selecting stability data comprises checking the operational data and scoring the data points based at least in part on stability.

11. The system of claim 8, wherein the modifying is based at least in part on performing a first analysis of gradient-based data reconciliation optimization, global-based data reconciliation optimization to remove any local minima, and one or more additional analysis of gradient-based data reconciliation optimization.

12. The system of claim 9, wherein the power plant model is based at least in part on a neural-net surrogate model, wherein the neural-net surrogate model indicates plant component degradation by reconciling the operational data, determining data match multipliers (DMMs), and determining performance factors.

13. The system of claim 9, wherein the neural net surrogate model is created based on a physics based model.

14. The system of claim 9, wherein the control action is determined from the DMMs and the performance factors.

15. A system comprising:
power plant equipment;
a controller in communication with the power plant equipment, wherein the controller includes a power plant control system; and
a processor in communication with the controller and configured to:
receive power plant operational data;
select stable data from the operational data to coincide with output data associated with a power plant model;
modify one or more parameters of the power plant model, wherein at least one difference is minimized between the output data associated with the power plant model and a measured value in the power plant operational data; and
determine at least one control action for a power plant component using the power plant model.

16. The system of claim 15, wherein the selecting stability data comprises checking the operational data and scoring the data points based at least in part on stability.

17. The system of claim 15, wherein the modifying is based at least in part on performing a first analysis of gradient-based data reconciliation optimization, global-based data reconciliation optimization to remove any local minima, and one or more additional analysis of gradient-based data reconciliation optimization.

18. The system of claim 15, wherein the power plant model is based at least in part on a neural-net surrogate model, wherein the neural-net surrogate model indicates plant component degradation by reconciling the operational data, determining data match multipliers (DMMs), and determining performance factors.

19. The system of claim 15, wherein the neural net surrogate model is created based on a physics based model.

20. The system of claim 15, wherein the control action is determined from the DMMs and the performance factors.
